(19) United States
(12) Patent Application Publication
(10) Pub. No.: US 2013/0248032 A1
(43) Pub. Date: Sep. 26, 2013

(54) HYDRAULIC PILOT VALVE ARRANGEMENT AND HYDRAULIC VALVE ARRANGEMENT HAVING THE SAME

(71) Applicant: ROBERT BOSCH GMBH, Stuttgart (DE)

(72) Inventor: Stefan Schmidt, Lohr (DE)

(73) Assignee: Robert Bosch GmbH, Stuttgart (DE)

(21) Appl. No.: 13/847,065

(22) Filed: Mar. 19, 2013

(30) Foreign Application Priority Data
Mar. 20, 2012 (DE) 10 2012 005 593.5

(51) Int. Cl. F15B 13/043

(52) U.S. Cl. CPC F15B 13/043
USPC 137/625.6; 137/596.14

(57) ABSTRACT

A hydraulic pilot valve arrangement for pilot-controlling a valve includes at least one pilot valve configured to be activated electromagnetically in a pulse-width-modulated fashion. The pilot valve is configured to be activated ballistically or inversely ballistically. A hydraulic valve arrangement including the hydraulic pilot valve arrangement also has a valve configured to be pilot-controlled by the pilot valve arrangement.

This application claims priority under 35 U.S.C. §119 to patent application no. DE 10 2012 005 593.5, filed on Mar. 20, 2012 in Germany, the disclosure of which is incorporated herein by reference in its entirety.

### BACKGROUND

The disclosure relates to a hydraulic pilot valve arrangement according to the description below and to a hydraulic valve arrangement having same according to the description below.

According to the prior art, a pressure medium volume flow can be conventionally controlled by means of a continuously adjustable proportional directional control valve with n connections and m switched positions. However, this conventional analog control of the pressure medium volume flow entails considerable expenditure in terms of device technology and control technology.

Simplifications in terms of device technology and control technology are made possible by the use of digital hydraulic concepts. In this context, each control edge of a conventional proportional directional control valve is triggered by means of at least one valve with at least one basic position and one switched position. In order to obtain the finest possible pressure medium volume control per control edge, this control edge is, however, preferably divided up into more than one switching valve, for example into four or five switching valves, wherein a ratio of the respective rated variables with respect to the smallest of the switching valves is, for example, 2, 4, 8, 16, . . . . A valve having four control edges can therefore be replaced by at least four switching valves. If a control edge is considered and it is assumed that four switching valves with a rated size of 1, 2, 4 and 8 are provided for this control edge, a number of 2⁴ possible magnitudes of volume flow occur owing to the exponential change in the rated variables. However, a disadvantage of this so-called pulse-coded modulation (PCM) is that relatively fine control of the pressure medium volume flow can be achieved only by means of a relatively large number of valves, which signifies a high level of expenditure in terms of device technology.

In order to set the volume flow more finely and to permit volume flows which are smaller than that of the respectively smallest valve of the arrangement, the concept of pulse width modulation can be applied (PWM). In this case, a rated volume flow of the valves which are actuated in this way can be reduced by virtue of the fact that the activation element of the valve is not connected through or fully opened continuously but instead only approximately within the time of a pulse or of the pulse length thereof. Subsequent to the pulse length, an inter-pulse period occurs in which the valve drops back from its switched position to the basic position. The size of the pressure medium volume flow can be set by means of a ratio of the pulse length to the sum of the pulse length and the inter-pulse period, the duty cycle. This already permits comparatively fine setting of the pressure medium volume flow.

European patent EP 0 828 946 B1 presents in this respect a pilot valve arrangement having a bridge circuit comprising four switching valves, wherein a valve body of a proportional directional control valve is clamped hydraulically into a first diagonal or into a bridge of the bridge circuit. A pressure medium input of a second diagonal of the bridge circuit is connected to a pressure medium source, and a pressure medium output of the second diagonal is connected to a pressure medium sink. Each switching valve has a basic position and a switched position and can be activated in an electromagnetically pulse-width-modulated fashion in order to control a pressure medium volume flow of the pilot valve arrangement.

A disadvantage of this solution is that for a required large bandwidth of the pressure medium volume flow, a plurality of switching valves with a different rated size would continue to be required. Alternatively, although a switching valve which switches very quickly and has a large rated size could be used, such a valve is expensive. However, the switching speed cannot be increased as desired and in addition the switching valve is subject to an increased risk of wear owing to the rapid switching.

In contrast, the disclosure is based on the object of providing a hydraulic pilot valve arrangement for pilot-controlling a valve, with which arrangement a pressure medium volume flow can be controlled more finely at a cost in terms of device technology which is the same as or lower than that of the prior art. Furthermore, the disclosure is based on the object of providing a hydraulic valve arrangement with a valve which is to be pilot-controlled and in which a pressure medium volume flow for pilot-controlling the valve can be controlled more finely at a cost in terms of device technology which is the same as or lower than that of the prior art.

These objects are achieved by means of a hydraulic pilot valve arrangement having the features described below or by means of a hydraulic valve arrangement having the features described below.

Advantageous developments of the disclosure are described below.

### SUMMARY

A hydraulic pilot valve arrangement for pilot-controlling an, in particular, hydraulic valve has at least one, or a first, pilot valve which can be activated electromagnetically in a pulse-width-modulated fashion and has a high pressure connection for connecting to a pressure medium source, a low pressure connection for connecting to a pressure medium sink and a first control connection for connecting to a first control chamber of the valve which is to be pilot-controlled. By means of an open position of the first pilot valve the first control connection can be connected to the high pressure connection or to the low pressure connection. According to the disclosure, the first pilot valve can be activated ballistically.

The term “ballistically” comprises here the ballistic and alternatively the inversely ballistic activation. For a detailed description of the ballistic activation, reference is made at this point to the publication “A Novel Model For Optimized Development And Application of Switching Valves in Closed Loop Control” (International Journal of Fluid Power 12, 2011, No. 3) by the applicant. Owing to this ballistic activation, the first pilot valve can assume intermediate positions (partial openings) which have an opening cross section which is smaller than a maximum open position and larger than a closed position of the first pilot valve. An electromagnetic activation element of the first pilot valve, for example an armature of an electromagnet, can either be unenergized or energized in a basic position in this context. The basic position of the pilot valve can be a throughflow position or an off position, or vice versa. The basic position is preferably spring-prestressed. If the basic position and the switched position of the first pilot valve are considered to be a bit with the values of zero or one, this bit is “divisible” by means of the principle of ballistic activation. The facts, frequently considered a disadvantage of digital hydraulics, that the switching elements are bulky and slow-acting and therefore unambiguously binary behavior is not possible permit fine setting of the pressure medium volume flow which is uncomplicated in terms of device technology by virtue of the disclosed combination with the ballistic activation. Compared to the conventional pulse width modulation in which the first pilot valve would be thrown completely into the switched position with each activation pulse and thrown back into the basic position in the subsequent inter-pulse period, the advantage of particularly fine control of the pressure medium volume flow is obtained. Compared to a conventional proportional directional control valve which is complex in terms of device technology and difficult to control, the ballistic activation according to the disclosure permits, for example, a valve which is configured in a simpler way in terms of device technology (a switching valve or a directional control valve) to be used. Said valve does not have to have a very short switching time either, in contrast to a conventional valve which is activated in an exclusively pulse-width-modulated fashion. This permits a switching valve with a large rated width and large volume flow bandwidth to be used.

For the ballistic activation here it is the case that a pulse length tᵢ of a ballistic activation pulse of the at least one pilot valve is larger than a minimum pulse length t_{i,min} of the at least one pilot valve starting from which minimum pulse length t_{i,min} a throw of a valve body of the at least one pilot valve out of the basic position thereof in the direction of a switched position takes place. In addition, the pulse length tᵢ here is so short that a complete throw of the valve body into the switched position does not take place. For the case of the inversely ballistic activation, the pulse length tᵢ of the activation pulse of the first pilot valve is at least so large that a complete throw of the valve body of the first pilot valve into the switched position thereof takes place. An inter-pulse period tₚ which follows the activation pulse and in which no activation pulse occurs is shorter here than a minimum inter-pulse period t_{p,min} which is necessary for a complete throw-back or return of the valve body into the basic position thereof to take place. The valve body is therefore thrown again in the direction of the switched position by a renewed activation pulse before it reaches its basic position. The pulse length tᵢ is preferably between 2 and 3 ms and is shorter than a switching delay time of the first pilot valve of, for example, 7 ms. The first pilot valve is preferably configured in such a way that it has a switching time tₛ for switching through into the switched position of approximately 7 ms, and a switching delay time t_{i,min} of approximately 2 ms. Of course, the pulse length tᵢ can also assume values which are equal to or greater than the switching time tₛ, with the result that the switched position after the switching time tₛ is switched through at least for the rest of the pulse length tᵢ. A basic frequency of the pulse width modulation is preferably lower than a maximum switching frequency of the first pilot valve. The basic frequency is particularly preferably approximately 0.5 to 1.0 times the maximum switching frequency. The specified preferred values of the variables t_{i,min}, tᵢ, tₚ, t_{p,min} and the relations thereof to one another preferably apply to all the pilot valves which can be activated ballistically in the following description.

One preferred variant of the hydraulic pilot valve arrangement has a second pilot valve which is connected in series with the first pilot valve in a pressure medium flow path from the high pressure connection to the low pressure connection. In this context, the first or the second pilot valve is arranged in a pressure medium flow path from the high pressure connection to the first control connection, and the respective other pilot valve of these two pilot valves, that is to say the second or the first, is arranged in a pressure medium flow path from the first control connection to the low pressure connection. In this way, in each case a pressure medium volume flow can be set from the high pressure connection to the low pressure connection, from the high pressure connection to the first control connection or first control chamber of the pilot valve to be pilot-controlled and from the latter to the low pressure connection. The second pilot valve can particularly preferably also be electromagnetically activated ballistically in a pulse-width-modulated fashion.

One preferred development of the hydraulic pilot valve arrangement has a second control connection for connecting to a second control chamber of the valve which is to be pilot-controlled. In this way, by simply acting on the respective control connection, a valve body of the valve which is to be pilot-controlled can be moved or thrown in opposite directions.

A particularly preferred development of the hydraulic pilot valve arrangement has a third and a fourth pilot valve. These two pilot valves are connected in series here in a pressure medium flow path from the high pressure connection to the low pressure connection. Furthermore, the third pilot valve or the fourth pilot valve is arranged in a pressure medium flow path from the high pressure connection to the second control connection, and the respective other pilot valve of these two pilot valves, that is to say the fourth or the third pilot valve, is arranged in a pressure medium flow path from the second control connection to the low pressure connection. This configuration of the hydraulic pilot valve arrangement corresponds to a bridge circuit with two diagonals wherein a first diagonal is formed by means of the first and the second control connections, and a second diagonal is formed by means of the high pressure connection and the low pressure connection. In this way, by means of the pilot valve arrangement a pressure medium volume flow can be respectively set from the high pressure connection to the low pressure connection, from the high pressure connection to the second control connection or second control chamber of the valve to be pilot-controlled and from said control connection or control chamber to the low pressure connection. At least the third or fourth pilot valve can particularly preferably also be activated ballistically in an electromagnetically pulse-width-modulated fashion. Both are particularly preferred.

In one particularly advantageous development of the hydraulic pilot valve arrangement, at least the first pilot valve is embodied as a 2/2-way switching valve. This means that under rated conditions a force, in particular a spring force, which prestresses a valve body, in particular a valve slide or valve piston, of the switching valve into a basic position is small compared to an activation force of the switching valve which results from the activation pulse. For this reason, a switching valve can very quickly be connected through into the switched position after the application of the activation pulse. For the further developments with two, three or four pilot valves, at least one of these further pilot valves is preferably embodied as a 2/2-way switching valve. All the pilot valves are particularly preferably configured in this way. The basic position of the pilot valve or valves can be a throughflow position with an open cross section or an off position with the cross section blocked, or vice versa.

In one alternative variant of the hydraulic pilot valve arrangement, the first pilot valve is a directional control valve which has at least three connections: the high pressure connection, the low pressure connection and the first control connection. The directional control valve is preferably configured in such a way that the directional control valve connects the first control connection to the high pressure connection or to the low pressure connection. The directional control valve is preferably a 3/3-way directional control valve.

So that the second control chamber of the valve which is to be pilot-controlled can also be actuated by means of the directional control valve, the hydraulic pilot valve arrangement also has the second control connection in one advantageous development. The directional control valve is then preferably configured as a 4/3-way directional control valve.

In one preferred development, at least the first and/or second and/or third and/or fourth pilot valve is configured as a seat valve or as a slider valve.

One particularly advantageous hydraulic pilot valve arrangement also has a control unit which is configured in such a way that by means of said control unit at least the first of the pilot valves can be controlled, in particular ballistically in an electromagnetically pulse-width-modulated fashion, or activated. A multiplicity or plurality of pilot valves, in particular all the pilot valves, can preferably be activated ballistically in an electromagnetically pulse-width-modulated fashion by means of the control unit.

It is to be emphasized that the pilot valve arrangement can also have more than four, for example five, six, seven or eight or more, pilot valves according to the preceding description.

A hydraulic valve arrangement has at least one pilot valve arrangement which is embodied according to the disclosure, as can be inferred from the preceding description. In addition, said valve arrangement has at least one valve which can be pilot-controlled by means of the pilot valve arrangement. In this context, the first control connection of the pilot valve arrangement is connected, or at least can be connected, to a first control chamber of the valve to be pilot-controlled. Compared to the prior art, owing to the advantages described above associated with the ballistic activation of the first pilot valve a hydraulic valve arrangement which is simplified in terms of device technology is provided by means of which a pressure medium volume flow for pilot-controlling the valve can also be controlled more finely.

A preferred variant of the hydraulic valve arrangement has a pilot valve arrangement which also has the second control connection which is described above and which can be connected, in particular is connected, to a second control chamber of the valve to be pilot-controlled.

In an alternative variant of the hydraulic valve arrangement, the first control chamber of the valve which is to be pilot-controlled is bounded, at least in certain sections, by means of a first control face of a valve body of the valve which is to be pilot-controlled, and a second control chamber of the valve which is to be pilot-controlled is bounded, at least in certain sections, by means of a second control face, counteracting the first, of the valve body. In this context, the second control chamber can be connected, in particular is connected, to a connection with an essentially constant pressure.

In a preferred development of this variant, the second control chamber of the valve which is to be pilot-controlled can be connected, in particular is connected, to the high pressure connection of the pilot valve arrangement. The pressure medium source with an essentially constant pressure is then the high pressure source, as a result of which either the high pressure or a pressure dependent thereon is present in the second control chamber. At maximum the high pressure is present in the first control chamber. So that the valve body of the valve to be pilot-controlled can be moved in a direction of action of the first control face despite the constant application of the high pressure, or of the pressure derived therefrom, to the second control face, the first control face is preferably larger than the second control face.

In an alternative development of this variant, the second control chamber of the valve which is to be pilot-controlled can be connected, in particular is connected, to the low pressure connection of the pilot valve arrangement or to a tank or to the atmosphere, and/or a force, in particular the force of a spring, which is directed counter to a direction of action of the pressure acting on the first control face, can be applied, in particular is applied, to the valve body of the valve which is to be pilot-controlled. The variant of the connection to the low pressure connection or the tank is preferred if the valve to be pilot-controlled is a slider valve and therefore a leakage current is possible from the first to the second control chamber. The variant of the connection to the atmosphere is preferred if the second control chamber is sealed by means of a valve seat and is therefore “dry”.

### BRIEF DESCRIPTION OF THE DRAWINGS

In the text which follows, seven exemplary embodiments of a valve arrangement according to the disclosure are explained in more detail on the basis of seven schematic figures, in which:

FIG. 1 shows a first exemplary embodiment of a valve arrangement having four 2/2-way pilot valves in a bridge circuit in a schematic lateral section;

FIG. 2 shows a schematic circuit diagram of a second exemplary embodiment with four 2/2-way pilot valves in a bridge circuit;

FIG. 3 shows a schematic circuit diagram of a third exemplary embodiment, analogous to the second exemplary embodiment, with a 4/3-way pilot directional control valve;

FIG. 4 shows a schematic circuit diagram of a fourth exemplary embodiment with two 2/2-way pilot valves;

FIG. 5 shows a schematic circuit diagram of a fifth exemplary embodiment, analogous to the fourth exemplary embodiment, with a 3/3-way pilot directional control valve;

FIG. 6 shows a schematic circuit diagram of a sixth exemplary embodiment with two 2/2-way pilot valves; and

FIG. 7 shows a schematic circuit diagram of a seventh exemplary embodiment, analogous to the sixth exemplary embodiment, with a 3/3-way pilot directional control valve.

For reasons of clarity, the same reference symbols have been used for parts or components which are configured in the same way in all the exemplary embodiments.

### DETAILED DESCRIPTION

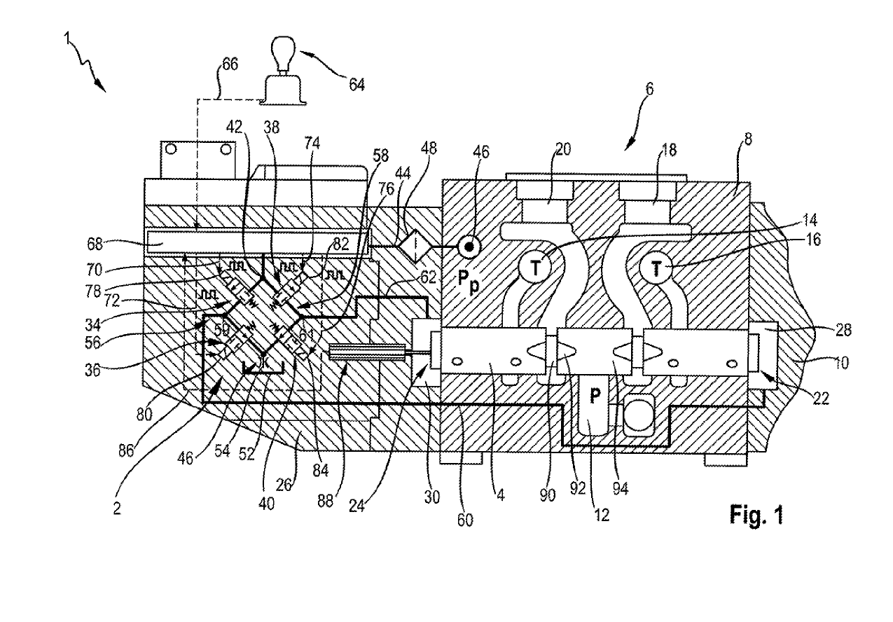

FIG. 1 shows a valve arrangement 1 with a pilot valve arrangement 2 which is connected by flanges to a valve block 8 of the valve 6 in order to activate a valve body 4, or a valve piston of a valve 6 which is embodied as a 4/3-way proportional directional control valve. An end plate 10 is connected by flanges to the valve block 8 opposite the pilot valve arrangement 2. The valve 6 has a high pressure chamber 12 which can be connected to a high pressure connection (not illustrated). Furthermore, the valve 6 has low pressure ducts 14 and 16 which can be connected to a tank connection (not illustrated). Two consumer connections 18, 20, via which the valve 6 can be connected to one or more consumers, are arranged on an upper side of the valve block 8 in FIG. 1.

According to FIG. 1, the valve body 4 is in a centered off position, with the result that the high pressure chamber 12 is blocked off with respect to the consumer connections 18, 20 and the low pressure ducts 14, 16. In a region of a first control face 22 to which control pressure can be applied and a second control face 24 of the valve body 4, both the end plate 10 and a housing 26 of the pilot valve arrangement 2 has a first control chamber 28 and a second control chamber 30. In order to displace the valve body 4 or to supply pressure medium to one or more loads which can be connected to the consumer connections 18, 20, a pressure medium volume flow can be applied to the control chambers 28, 30 via the pilot valve arrangement 2. Since the two control faces 22, 24 are of equal size, the valve body 4 is displaced into the control chambers 28, 30 at different pressures. The displacement continues until there is no pressure difference anymore between the control chambers 28, 30.

In order to control the pressure medium volume flows directed into the control chambers 28, 30, the pilot valve arrangement 1 has a bridge circuit 32 with a first, second, third and fourth pilot valve 34, 36, 38 and 40. The pilot valves 34 to 40 are embodied here as 2/2-way switching valves. Each of the pilot valves 34 to 40 has a spring-prestressed basic position and a switched position which can be activated electromagnetically. The bridge circuit 32 has a high pressure connection 42 which is connected to a pressure medium source 46 via a pressure medium duct 44. A filter 48 is arranged in the pressure medium duct 44. The bridge circuit 32 is configured in a way analogous to a Wheatstone measuring bridge. Accordingly, the first and third pilot valves 34 and 38 are connected to the high pressure connection 42 in a parallel circuit. Furthermore, the second and fourth pilot valves 36 and 40 are connected to a low pressure connection 50 of the bridge circuit 32 in a parallel circuit, wherein the low pressure connection 50 is in turn connected to a pressure medium sink 52 or a tank. A restrictor 54 is connected upstream of the low pressure connection 50.

The bridge circuit 32 therefore has two parallel pressure medium flow paths 56, 58 between its high pressure connection 42 and its low pressure connection 50, wherein in a first pressure medium flow path 56 the first pilot valve 34 is arranged connected in series with the second pilot valve 36. In the second pressure medium flow path 58 of the bridge circuit 32, in an analogous fashion the third pilot valve 38 is arranged connected in series with the fourth pilot valve 40. In this context, the first pilot valve 34 is connected to the second pilot valve 36 via a connecting line, and the third pilot valve 38 is connected to the fourth pilot valve 40 via another connecting line. In this context, a control line 60, 62 branches off from each of the two connecting lines. In this context, a pressure medium outlet of the first pilot valve 34 is connected to the first control chamber 28 via the first control connection 59 and the first control line 60, and a pressure medium outlet of the third pilot valve 38 is connected to the second control chamber 30 via the second control connection 61 and the second control line 62. In this way, the two control lines 60, 62 form a first diagonal bridge in which the valve body 4 of the valve 6 is hydraulically clamped in.

The position of the valve body 4 and therefore the pressure medium supply of the consumer connections 18 and 20 is, as already mentioned, controlled by means of the pilot valve arrangement 2. The latter is connected to an operator control unit 64 by means of which an operator can predefine a setpoint value for a hydraulic consumer which can be connected to one of the consumer connections 18, 20 or to both of said consumer connections 18, 20. The operator control unit 64 is for this purpose connected to a control unit 68 of the valve arrangement 1 via a signal line 66. The pilot valves 34, 36 and 38, 40 are connected to the control unit 68 via further signal lines 70, 72 and 74, 76. The specified signal lines 70 to 76 constitute a signal connection between the control unit 68 and the respective electromagnets 78 to 84 of the pilot valves 34 to 40, and permit the energization thereof. Furthermore, there is a signal connection between a travel pickup 88 of the valve body 4 and the control unit 68 via a signal line 86. In a correct operating mode, a position or deflection of the valve body 4 is continuously communicated to the control unit 68 via the travel pickup 88.

Each of the pilot valves 34 to 40 is configured as a 2/2-way switching valve and has in each case a spring-prestressed basic position and a switched position which can be activated electromagnetically. The first pilot valve 34 and the third pilot valve 38, which are arranged adjacent to the high pressure connection 42 in the bridge circuit, have here a spring-prestressed closed position as a basic position. The pilot valves 36 and 40 which are arranged adjacent to the low pressure connection 50 have, on the other hand, a spring-prestressed open position as a basic position.

If the consumer connection 20 is then to be connected to the high pressure chamber 12 by means of the valve 6, the valve body 4 in FIG. 1 must be displaced to the right in such a way that a control chamfer 92, which merges with a control groove 90, of the valve body 4 projects into the high pressure chamber 12. In this context it is to be noted that the high pressure chamber 12 extends out of the plane of view in FIG. 1, opposite the viewer, partially around a control collar 94 of the valve body 4. In this way, a pressure medium connection from the high pressure chamber 12 is produced to the consumer connection 20 via a control gap, which is bounded by the control chamfer 92 and a wall of the valve block 8. The further the valve body 4 is moved to the right here, the larger the control gap via which pressure medium can flow from the high pressure chamber 12 to the consumer connection 20.

FIG. 1 shows clearly that if the valve body 4 is to be displaced to the right, as prescribed, pressure medium has to be applied to the second control chamber 30 from the high pressure connection 42 via the third pilot valve 38, and to the second control line 62, with the result that a higher pressure is set in the second control chamber 30 than in the first control chamber 28 lying opposite. The subsequent displacement of the valve body 4 and the incompressibility of the pressure medium result in a pressure medium volume flow having to be made possible from the first control chamber 28 to the low pressure connection 50 via the control line 60 and the second pilot valve 36. In this example, the control unit 68 therefore has the object of keeping the first pilot valve 34 in its closed basic position, of actuating the third pilot valve 38 in the direction of its switched position or open position, of leaving the second pilot valve 36 in its open position or of throttling it ballistically in the direction of its closed position, and of actuating the fourth pilot valve 40 into its closed position. A pressure medium volume flow can then flow from the high pressure connection 42 to the second control chamber 30, and an approximately equally large pressure medium volume flow can flow from the first control chamber 28 to the low pressure connection 50.

According to the strength of the setpoint value signal transmitted from the operator control unit 64 to the control unit 68, the need arises for a more or less rapid deflection of the valve body 4 to the right. This results in the required size of the pressure medium volume flow to the second control chamber 30 or of the pressure medium volume flow of the first control chamber 28. All four pilot valves 34 to 40 can be activated electromagnetically in a pulse-width-modulated fashion. This method of activation is symbolized in FIG. 1 by means of four schematically illustrated pulse profiles. Ballistic is to be understood here as meaning that an activation pulse is not sufficient to connect the corresponding pilot valve through as far as its switched position if an intermediate position of the corresponding pilot valve is desired. For the third pilot valve 38, via which the second control chamber 30 is to be filled with pressure medium, it is assumed that the intended adjustment of the valve body 4 in FIG. 1 to the right is to take place very slowly. Accordingly, the pressure medium volume flow into the second control chamber 30 must be metered finely at a low rate. For this purpose, the electromagnet of the pilot valve 38 is supplied, via the signal line 74 and the control unit 68, with pulses which have a pulse length t, which is only slightly greater than a minimum pulse length t_{i,min} which is necessary to lift the valve body of the third pilot valve 38 off from its basic position. In this way, the valve body of the pilot valve 38 is thrown in a periodically recurring fashion into an intermediate position with a minimum opening cross section, and in the following inter-pulse period it drops back into the spring-prestressed basic position or closed position. This results in a very small pressure medium volume flow to the second control chamber 30. It is to be noted that at the same time the fourth pilot valve 40 is actuated via the control unit 68 and the signal line 76 in such a way that it is continuously blocked in its switched position or closed position. For this purpose, the pulse length tᵢ can have a value which exceeds the switching time t, of the fourth pilot valve 40. The fourth pilot valve 40 is therefore closed continuously. At the same time, the second pilot valve 36 remains opened in its spring-prestressed basic position or open position. During this time it is ensured that the first pilot valve 34 is also blocked in its spring-prestressed basic position or closed position. In this way, a pressure medium volume flow which is generated into the first control chamber 28 by the displacement of the valve body 4 can flow away via the control line 60 and the second pilot valve 36 to the low pressure connection 50 and into the tank 52.

During this control process, the measured value of the travel pickup 88 or the position of the valve body 4 is continuously fed back to the control unit 68 via the signal line 86. If the pressure medium volume flow at the consumer connection 20 then corresponds to the setpoint value predefined via the operator control unit 64, the control unit 68 brings about an end to the movement of the valve body 4 in the valve block 8. For this purpose, the pressure medium quantities which are located in the control lines 60 and 62 and in the control chambers 28 and 30 must be kept constant. Assuming that no leakage occurs in the system considered, this is successful by virtue of the fact that the first and third pilot valves 36 and 38 are not energized, as a result of which they drop into their spring-prestressed closed position or basic position. Furthermore, the second and fourth pilot valves 36 and 40 are switched through into their closed position or switched position via the control unit 68 and the signal lines 72 and 76.

If correspondingly larger pressure medium volume flows are conveyed from the high pressure connection 42 to the control chambers 28 and 30, an opening cross section of the pilot valves 34 (first) or 38 (third) is to be enlarged as a function of the intended direction of movement of the valve body 4. This is achieved in a particularly finely graduated fashion by means of the ballistically pulse-width-modulated electromagnetic activation. For the intended relatively large volume flows, the pulse length tᵢ of the activation pulse is to be enlarged here compared to the case described above.

With respect to the case under discussion it is to be noted that a pressure medium volume flow which is actually conveyed into the second control chamber 30 can be reduced by the open position of the fourth pilot valve 40. In this context, a circumference of the reduction can be set in a ballistically pulse-width-modulated fashion as described above. For this purpose, the control unit 68 applies pulses with a corresponding pulse length to the electromagnet 84 of the fourth pilot valve 40. In this context, each pulse throws the valve body counter to the spring force in the direction of the switched position or closed position. In this context, the fourth pilot valve 40 fulfils a function which throttles all the more strongly the longer the pulse length tᵢ. The fourth pilot valve 40 is completely closed if the pulse length tᵢ is sufficiently long and the inter-pulse period tₚ is sufficiently short, with the result that the valve body remains in its switched position. In this case, the complete pressure medium volume flow of the third pilot valve 38 flows into the second control chamber 30. Of course, the same applies to the case of filling the first control chamber 28 via the first pilot valve 34 and the control line 60. In this case, the second pilot valve 36 performs the above-described function of the fourth pilot valve 40.

Furthermore it is to be noted that a pressure medium volume flow which is fed into the control chambers 28 and 30 can be influenced not only as described above but also via throttling of the pressure medium volume flow which flows out of the respective other control chamber 30 or 28. The stronger this throttling is, the slower the rate at which the control chamber to be filled will fill with pressure medium, which results in a relatively slow displacement of the valve body 4.

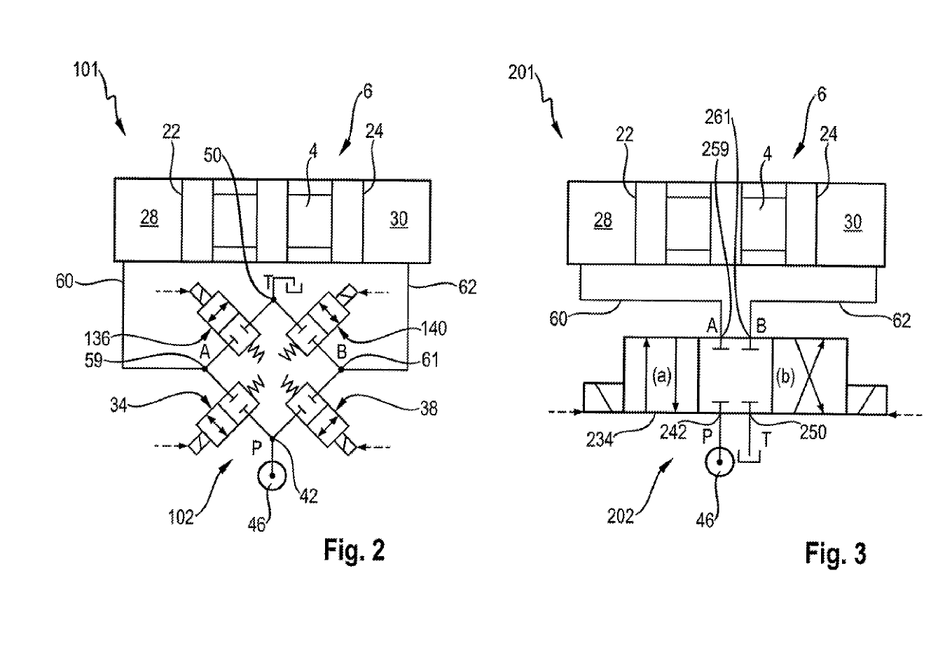

FIG. 2 shows a valve arrangement 101 with a pilot valve arrangement 102 via which the valve 6 is pilot-controlled. This corresponds here to the valve 6, to be pilot-controlled, of the first exemplary embodiment according to FIG. 1. In addition, the pilot valve arrangement 102 corresponds largely to the pilot valve arrangement 2 of the first exemplary embodiment, but deviates therefrom with respect to a second and a fourth pilot valve 136, 140. In contrast to the second and fourth pilot valves 36, 40 according to FIG. 1, the pilot valve 136, 140 is spring-prestressed in its closed position. Otherwise, the second exemplary embodiment according to FIG. 2 corresponds to the first exemplary embodiment according to FIG. 1.

FIG. 3 shows a technically similar solution to the second exemplary embodiment according to FIG. 2. A valve arrangement 201 has here a pilot valve arrangement 202 for pilot-controlling the valve 6. In contrast to the exemplary embodiments above, the pilot valve arrangement 202 now has, instead of a plurality of pilot valves, merely a first pilot valve 234 which is configured as a 4/3-way directional control valve. The first pilot valve 234 has a high pressure connection 142 which is connected to the pressure medium source 46, a low pressure connection 250 which is connected to a tank, a first control connection 259 which is connected to the first control chamber 28 of the valve 6 via the first control line 60, and a second control connection 261 which is connected to the second control chamber 30 of the valve 6 via the second control line 62. Similarly to the two preceding exemplary embodiments, the first pilot valve 234 is activated in an electromagnetically pulse-width-modulated fashion and ballistically via the signal lines indicated by dashed lines.

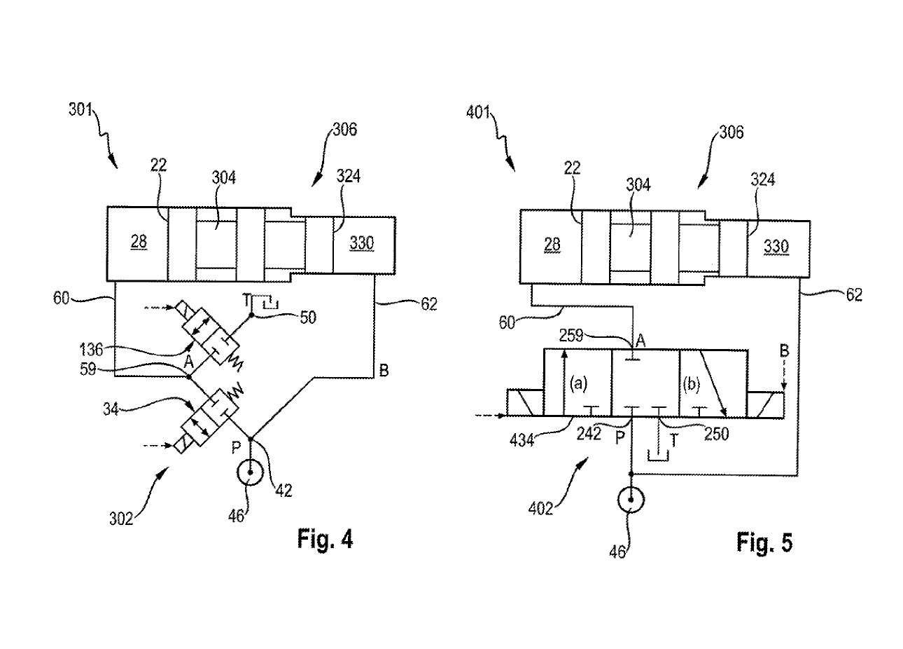

FIG. 4 shows a valve arrangement 301 which is simplified in terms of device technology and has a pilot valve arrangement 302 which, in contrast to the second exemplary embodiment according to FIG. 2 only has one pressure medium flow path with the first pilot valve 34 and the second pilot valve 136 between the high pressure connection 42 and the low pressure connection 50. The two pilot valves 34, 136 correspond to the pilot valves of the exemplary embodiment according to FIG. 2 which are designated identically. In contrast to all the preceding exemplary embodiments, in this one the high pressure connection 42 is connected directly to a second control chamber 330 of the valve 306 via the second control line 62. The high pressure is therefore always present in the second control chamber 330. Said high pressure is preferably essentially constant but can also be variable. Displacement of a valve body 304 of the valve 306 in FIG. 4 from the left to the right therefore takes place counter to the high pressure of the high pressure connection 42 acting in the second control chamber 330. Since in the case of a full open position of the first pilot valve 34 in the first control chamber 28 of the valve 306 this high pressure is the maximum which can be present, a second control face 324, via which the second control chamber 330 is limited, is reduced compared to the first control face 22 via which the first control chamber 28 is limited. As a result, an inequilibrium of forces can occur for the purpose of displacing the valve body 304. The valve body 304 in FIG. 4 is displaced from right to left by means of the electromagnetically pulse-width-modulated and ballistic activation of the second pilot valve 136, as a result of which pressure medium can flow out of the first control chamber 28 to the low pressure connection 50. The first pilot valve 36 remains in its spring-prestressed closed position here.

A solution which is technically similar to the fourth exemplary embodiment according to FIG. 4 is presented by the fifth exemplary embodiment of a valve arrangement 401 according to FIG. 5. It differs from the valve arrangement 301 according to FIG. 4 only in the configuration of its pilot valve arrangement 402. The latter merely has a first pilot valve 434 which is configured as a 3/3-way directional control valve. The first pilot valve 434 has a high pressure connection 242 which is connected to the pressure medium source 46, a low pressure connection 250 which is connected to the tank, and the first control connection 259 which is connected to the first control chamber 28 via the first control line 60. The valve 306 corresponds to that in the fourth exemplary embodiment according to FIG. 4. The first pilot valve 434 corresponds here to the first pilot valve 434 of the following seventh exemplary embodiment according to FIG. 7 and is also activated into both switched positions a, b in an electromagnetically pulse-width-modulated fashion and ballistically.

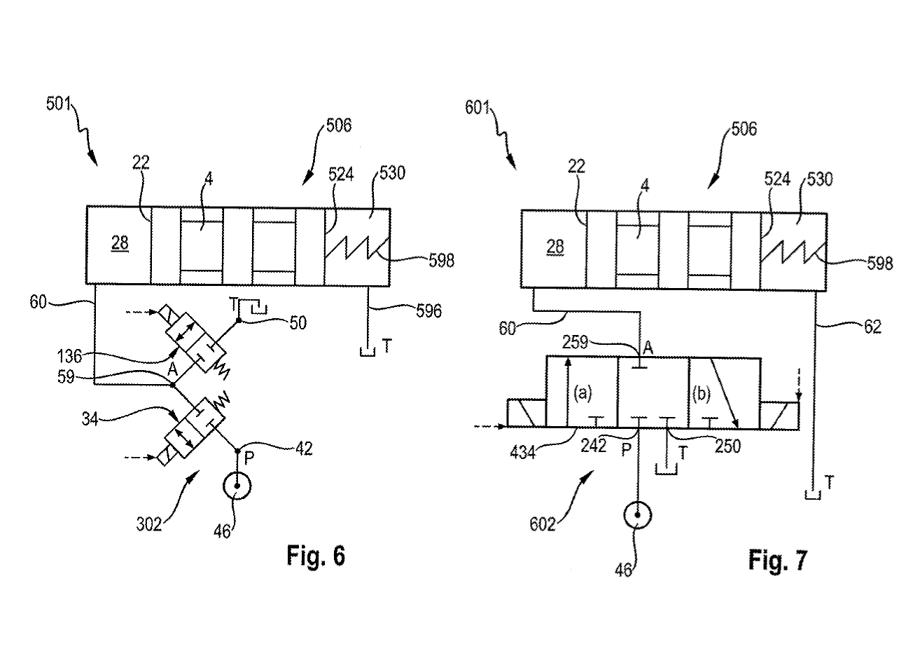

FIG. 6 shows a sixth exemplary embodiment of a valve arrangement 501 with the pilot valve arrangement 302 such as is already known from the fourth exemplary embodiment according to FIG. 4, and with a valve 506 to be pilot-controlled. The valve arrangement 501 differs from the valve arrangement 301 according to FIG. 4 only in the region of a second control face 524 of a second control chamber 530 and the pressure medium supply thereof. The second control chamber 530 is, in contrast to all the preceding exemplary embodiments, connected neither to a second control connection nor to a high pressure connection of the pilot valve arrangement. Instead, it is connected via a tank line 596 to a tank T which has a low pressure level. Since this pressure level is not sufficient to bring about an equilibrium of forces at the valve body 4 when pressure medium is applied to the first control chamber 28 via the high pressure connection 42, the valve body 4 is supported via its second control face 524 on a valve spring 598. In the case of displacement of the valve body 4 in FIG. 6 to the right, in that the first control chamber 28 is filled with pressure medium by means of the correspondingly ballistic activation of the first pilot valve 34, the valve spring 598 is correspondingly compressed. As the displacement path of the valve body 4 becomes larger, the spring force thereof, which counteracts a compressive force resulting from the first control face 22 to which high pressure is applied, increases. If the valve body 4 in FIG. 6 is to be pushed to the left, the first pilot valve 34 is no longer actuated (ballistically) and drops back into its spring-prestressed closed position. In addition, in this context the second pilot valve 136 is actuated ballistically in the direction of its switched position or open position with the result that pressure medium can flow from the first control chamber 28 to the tank T via the first control line 60 and the second pilot valve 136.

The seventh and last exemplary embodiment according to FIG. 7 shows a valve arrangement 601 which differs from the valve arrangement 501 according to FIG. 6 only in having a valve arrangement 602. In principle, the valve arrangement 302 according to FIG. 6 is replaced by a first pilot valve 434 as is already shown in the fifth exemplary embodiment according to FIG. 5. The actuation and the method of functioning of the valve 506 corresponds here to that of the exemplary embodiment according to FIG. 6. The configuration and the method of functioning of the first pilot valve 434 in FIG. 7 correspond to the pilot valve 434 according to FIG. 5.

All the signal lines which are indicated by dashed lines in the figures and are without reference numbers connect the respective electromagnet of the pilot valve to a control unit according to FIG. 1. The control unit is not illustrated for reasons of clarity.

The pilot valves which are shown are not restricted to ballistic or inversely ballistic activation but instead can also be configured in such a way that conventional, in particular pulse-width-modulated, activation is possible.

Each of the pilot valves can have the closed position or the open position as a home position. Likewise, each of the pilot valves can be actuated ballistically or inversely ballistically. The selection of the basic position and/or the type of ballistic activation depends on the respective application of the valve arrangement or pilot valve arrangement.

In contrast to the exemplary embodiment shown, the pilot valve arrangement can have more than four pilot valves, for example six or eight. Likewise, two or more of the pilot valve arrangements can be provided connected together, in particular connected in parallel with one another, for a valve arrangement.

A hydraulic pilot valve arrangement for pilot-controlling a valve is disclosed, said pilot valve arrangement having at least one pilot valve which can be activated in an electromagnetically pulse-width-modulated fashion. In this context, the pilot valve can be activated ballistically or inversely ballistically. Furthermore, a hydraulic valve arrangement having the pilot valve arrangement and having a valve which can be pilot-controlled via the pilot valve arrangement is disclosed

What is claimed is:

1. A hydraulic pilot valve arrangement for pilot-controlling a valve comprising:
a first pilot valve configured to be activated electromagnetically in a pulse-width-modulated manner;
a high pressure connection configured to connect to a pressure medium source and a low pressure connection configured to connect to a pressure medium sink; and
a first control connection configured to connect to a first control chamber which is pilot-controlled, wherein when the first pilot valve is in an open position, the first control connection is configured to be connected to one of the high pressure connection and the low pressure connection, and wherein the first pilot valve is configured to be activated ballistically.

2. The pilot valve arrangement according to claim 1, further comprising:
a second pilot valve connected in series with the first pilot valve in a pressure medium flow path from the high pressure connection to the low pressure connection, wherein:
one of the first pilot valve and the second pilot valve is arranged in a pressure medium flow path from the high pressure connection to the first control connection, and
the other of the first pilot valve and the second pilot valve is arranged in a pressure medium flow path from the first control connection to the low pressure connection.

3. The pilot valve arrangement according to claim 1, further comprising:
a second control connection configured to connect to a second control chamber of the valve which is pilot-controlled.

4. The pilot valve arrangement according to claim 3, further comprising:
a third pilot valve; and
a fourth pilot valve, wherein
the third pilot valve is connected in series with the fourth pilot valve in a pressure medium flow path from the high pressure connection to the low pressure connection,
one of the third pilot valve and the fourth pilot valve is arranged in a pressure medium flow path from the high pressure connection to the second control connection, and
the other of the third pilot valve and the fourth pilot valve is arranged in a pressure medium flow path from the second control connection to the low pressure connection.

5. The pilot valve arrangement according to claim 1, wherein at least the first pilot valve is configured as a 2/2-way switching valve.

6. The pilot valve arrangement according to claim 1, wherein the first pilot valve is a directional control valve which includes the high pressure connection, the low pressure connection, and the first control connection.

7. The pilot valve arrangement according to claim 6, wherein the directional control valve includes the second control connection.

8. The pilot valve arrangement according to claim 1, wherein at least the first pilot valve is configured as one of a seat valve and a slider valve.

9. The pilot valve arrangement according to claim 1, wherein at least one of the second pilot valve, the third pilot valve, and the fourth pilot valve is activated ballistically in an electromagnetically pulse-width-modulated manner.

10. The pilot valve arrangement according to claim 1, further comprising:
a control unit configured to balistically activate at least the first pilot valve in an electromagnetically pulse-width-modulated manner.

11. A hydraulic valve arrangement comprising:
at least one pilot valve arrangement including:
a first pilot valve configured to be activated electromagnetically in a pulse-width-modulated manner,
a high pressure connection configured to connect to a pressure medium source and a low pressure connection configured to connect to a pressure medium sink, and
a first control connection configured to connect to a first control chamber which is pilot-controlled, wherein when the first pilot valve is in an open position, the first control connection is configured to be connected to one of the high pressure connection and the low pressure connection, and wherein the first pilot valve is configured to be activated ballistically; and
at least one valve which is pilot-controlled by the pilot valve arrangement, wherein the first control connection of the pilot valve arrangement is configured to connect to a first control chamber of the at least one valve which is pilot-controlled.

12. The valve arrangement according to claim 11, wherein:
the pilot valve arrangement further includes a second control connection, and
the second control connection is configured to connect to a second control chamber of the at least one valve which is pilot-controlled by the pilot valve arrangement.

13. The valve arrangement according to claim 11, wherein:
the first control chamber is bounded, at least in certain sections, by a first control face of a valve body of the at least one valve which is pilot-controlled by the pilot valve arrangement,
a second control chamber of the at least one valve which is pilot-controlled by the pilot valve arrangement is bounded, at least in certain sections, by a second control face of the valve body which is configured to counteract the first control face, and
the second control chamber is configured to connect to a connection with an essentially constant pressure.

14. The valve arrangement according to claim 13, wherein:
the second control chamber is configured to connect to the high pressure connection of the pilot valve arrangement, and
the first control face is greater than the second control face.

15. The valve arrangement according to claim 13, wherein:
the second control chamber is configured to connect to one of the low pressure connection of the pilot valve arrangement, a tank, and an atmosphere.

16. The valve arrangement according to claim 13, wherein:
a force, which is directed counter to a direction of action of pressure acting on the first control face, is configured to be applied to the valve body of the at least one valve which is pilot-controlled by the pilot valve arrangement.
